(19) United States
(12) Patent Application Publication
(10) Pub. No.: US 2026/0274230 A1
(43) Pub. Date: Sep. 17, 2026

(54) BRAKING SYSTEM FOR A MOTOR VEHICLE

(71) Applicant: Continental Automotive Technologies GmbH, Hannover (DE)

(72) Inventors: Christian Courth, Frankfurt (DE); Holger Kollmann, Rodgau (DE)

(73) Assignee: Continental Automotive Technologies GmbH, Hannover (DE)

(21) Appl. No.: 18/869,072

(22) PCT Filed: May 16, 2023
(86) PCT No.: PCT/DE2023/200102

§ 371 Date: Nov. 25, 2024

(30) Foreign Application Priority Data
May 25, 2022 (DE) 10 2022 205 225.0

(51) Int. Cl. B60T 13/68; B60T 13/74

(52) U.S. Cl. CPC B60T 13/686; B60T 13/745; B60T 2270/403; B60T 2270/413

(57) ABSTRACT

A braking system for a motor vehicle is divided into two modules, each module having a respective electrical pressure supply device. A separation valve is connected in a module, the separation valve having two valve seats, which can be opened at different pressure differences. This enables the functionality of two valves to be integrated in one valve.

### CROSS-REFERENCE TO RELATED APPLICATIONS

This application is a national stage application, filed under 35 U.S.C. § 371, of International Patent Application No. PCT/DE2023/200102, filed on May 16, 2023, which claims priority to German patent application No. 10 2022 205 225.0, filed on May 25, 2022, each of which is incorporated by reference

### TECHNICAL FIELD

The technical field relates to a braking system for a motor vehicle.

### BACKGROUND

Braking systems are typically used in motor vehicles to decelerate the motor vehicle in a targeted manner. Known braking systems are in particular of hydraulic design and are based on the fact that a driver actuates a master brake cylinder by means of a brake pedal and a pressure generated in the process acts directly on wheel brakes. If necessary, this pressure can be increased, for example by known brake boosters. More recent braking systems make use, for example, of the principle that, although a pressure is generated in the master brake cylinder, said pressure is conducted to a simulator in a normal braking mode, with a driver's braking request being sensed and converted into a braking effect exclusively by an electrically operated pressure generator. In the normal braking mode, the driver-actuable master brake cylinder is thus decoupled from the wheel brakes. Typically, only in the event of a failure of the electrical pressure supply is provision made that otherwise closed valves open and permit direct pressurization of wheel brakes by means of the master brake cylinder. In the future, braking systems are intended to be designed in such a way that such a hydraulic fallback level can be dispensed with, with the corresponding redundancy typically having to be provided in some other way. Braking systems of this type can also be divided into a plurality of modules.

It is desirable to provide a braking system for a motor vehicle, which is designed alternatively or better in comparison to known embodiments.

### SUMMARY

The disclosed subject matter relates to a braking system for a motor vehicle. The braking system has a first module, in which at least one reservoir port and one module port are formed. The braking system has a second module, in which a plurality of wheel ports are formed. The braking system has a first electrical pressure supply device, which is arranged in or on the first module, is connected on the pressure side to the module port and is connected on the suction side to the reservoir port. The braking system has a second electrical pressure supply device, which is arranged in or on the second module and is connected on the pressure side to the wheel ports. The braking system has a first separation valve, which is connected in the second module between the module port and the wheel ports. The second electrical pressure supply device is connected on the pressure side to a connection between the first separation valve and at least some of the wheel ports.

The first separation valve has a first valve seat and a second valve seat. The first valve seat and the second valve seat are hydraulically connected in parallel. The second valve seat when open has a larger passage than the first valve seat.

The first separation valve is normally open. The first valve seat and the second valve seat are jointly closable by actuation of the first separation valve. The second valve seat is spring-loaded in such a way that, if the first separation valve is not actuated, it opens only if a positive pressure on the side of the second electrical pressure supply device is less than a threshold value.

The design described above makes it possible to implement a braking system which does not require a hydraulic fallback level. Two electrical pressure supply devices which can build up a pressure independently of each other are available. If, for example, one of the electrical pressure supply devices fails, the other can still generate a brake pressure, and therefore safety is maintained. By using the described first separation valve, it is possible in a simple manner to ensure that brakes are depressurized when the braking system is switched off, for example when a vehicle is stationary. In this case, at least the first valve seat of the first separation valve opens and thus permits a reduction of pressure. From a pressure difference above the first separation valve, which is sufficiently low, i.e., is in particular below the threshold value, the first separation valve opens completely, in particular by opening the second valve seat.

In particular, the two modules can be handled and/or placed independently of each other. The pressure supply devices can be designed in particular to generate, by electrical application, a hydraulic pressure, which can then be used in wheel brakes for generating a braking effect. In particular, the two modules can be positioned independently of each other, which increases the flexibility. The first separation valve can be used in particular to ensure the supply of brake fluid to the second electrical pressure supply device. This also applies in particular in the event of a power failure in the first module or at the first separation valve.

The normally open design means in particular that at least one of the valve seats opens when the power supply is switched off. This may mean that the first valve seat opens. Depending on a spring loading design, such an opening can take place independently of the prevailing pressure, or it can take place when a prevailing pressure difference falls below a predetermined value. In particular, this predetermined value may be greater, preferably considerably greater, than the threshold value. Such a design is also typically referred to as normally open in the case of valves known from the prior art. If the second valve seat then opens, in particular after a pressure equalization and at a pressure difference that is smaller than the first threshold value, this may mean that the first valve seat is thereby closed, in particular because the first valve seat forms a stop for the second valve seat. In this case, however, the second valve seat is open, and therefore the valve remains open.

In particular, an actuation of the first separation valve in order to close both valve seats, in particular independently of the prevailing pressures, is sufficient. It can thus be ensured that the valve is closed when this is required. A threshold value can be selected in particular by means of a suitable configuration of a spring which keeps the valve or the second valve seat in the open state. A positive pressure can firstly be reduced by means of the first valve seat, and then the second valve seat opens such that the valve opens completely.

In one embodiment, no non-return valve is connected parallel to the first separation valve. Such a non-return valve can be advantageously dispensed with, since the first separation valve in its described design ensures that it opens reliably when this is required.

According to one embodiment, the braking system furthermore has a second separation valve, which is connected on the one hand to a connection between the first electrical pressure supply device and the first separation valve and is connected or connectable on the other hand to a brake fluid reservoir. This allows a direct fluid connection to a brake fluid reservoir such that a pressure equalization is possible via the second separation valve.

Parallel to the second separation valve, a non-return valve with a passage direction from the brake fluid reservoir is in particular connected to the connection between the first electrical pressure supply device and the first separation valve. This allows an even more reliable replenishing function. In particular, the second separation valve can be normally open. This allows pressure to be reduced and/or replenished even in the event of a power failure at the second separation valve.

According to one embodiment, the module port is connected exclusively to the first electrical pressure supply device. The first electrical pressure supply device can in particular have a breather hole, which is opened only in an inoperative state of the first electrical pressure supply device, wherein the breather hole is in particular connected to the reservoir port. This allows pressure from brake circuits to be reduced via the breather hole. In particular, it can be provided that a possible positive pressure from the brake circuits firstly displaces a piston of the first electrical pressure supply device into an inoperative state, as a result of which the breather hole is then opened and the pressure is reduced. The inoperative state can be defined in that a piston of the second electrical pressure supply device is in a fully retracted state.

According to one embodiment, a non-return valve or a plurality of non-return valves with a passage direction to the second electrical pressure supply device is or are connected directly on the input side to the second electrical pressure supply device. According to one embodiment, a non-return valve or a plurality of non-return valves with a passage direction away from the second electrical pressure supply device is or are connected directly on the output side to the second electrical pressure supply device. This ensures that fluid flows through the second electrical pressure supply device in the correct direction.

The first module may in particular have a control device and the second module may in particular have a second control device separate from the first control device. The control devices can control the respective module. They can also have divided or distributed functionalities. In particular, they can be designed in such a way that the braking system remains functional at least to a limited extent if one of the two control devices fails. This generates a redundancy.

The second electrical pressure supply device can be connected in particular via a circuit separation valve to the connection between the first separation valve and at least some of the wheel ports. In particular, this may relate to a pressure side of the second electrical pressure supply device. This enables the second electrical pressure supply device to advantageously apply pressure to all of the wheel ports of the second module.

In particular, a first brake circuit and a second brake circuit can be formed in the second module. Each brake circuit can be assigned one or more wheel ports. In particular, the first brake circuit can be directly connected to the first circuit separation valve. In particular, the second brake circuit can be connected to the first brake circuit via the circuit separation valve. The wheel ports of the second brake circuit can thus be directly pressurized by the second electrical pressure supply device. The wheel ports of the first brake circuit can also be pressurized via the circuit separation valve. In addition, the circuit separation valve can also be used to supply pressure to the second brake circuit from the first electrical pressure supply device, wherein the first brake circuit can typically be directly pressurized by the first electrical pressure supply device via the first separation valve.

In particular, the second electrical pressure supply device can be directly connected on the pressure side to the second brake circuit. This allows the second brake circuit to be directly pressurized.

In particular, an inlet valve can in each case be connected between the electrical pressure supply devices and the wheel ports. The wheel ports can be connected via respective outlet valves to a suction side of the second electrical pressure supply device and/or to a brake fluid reservoir or to a connection to a brake fluid reservoir. The inlet valves and the outlet valves allow selective pressurization and selective pressure reduction for each individual wheel.

According to one embodiment, the braking system furthermore has a connection line, which originates from the second module for the direct connection to a brake fluid reservoir and which is connected to a suction side of the second electrical pressure supply device and/or to outlet valves. This allows the second electrical pressure supply device to be directly aspirated without additional components being required for this. In addition, when the connection line is connected to the outlet valves, pressure can be reduced immediately and discharged into the brake fluid reservoir.

According to one advantageous embodiment, the first electrical pressure supply device is a linear actuator. The second electrical pressure supply device is advantageously a piston pump. Linear actuators typically operate according to the hydrostatic principle, with displaced volume being conducted directly into the wheel brake cylinder. Piston pumps typically operate according to the hydrodynamic principle, with a pressure being built up, which is used in a suitable manner by appropriate distribution.

### BRIEF DESCRIPTION OF THE DRAWINGS

Further features and advantages will be gathered by a person skilled in the art from the exemplary embodiment described below with reference to the appended drawings, in which:

FIG. 1: shows a braking system according to a first exemplary embodiment,

FIG. 2: shows a braking system according to a second exemplary embodiment, and

FIG. 3 shows a valve according to one embodiment.

### DETAILED DESCRIPTION

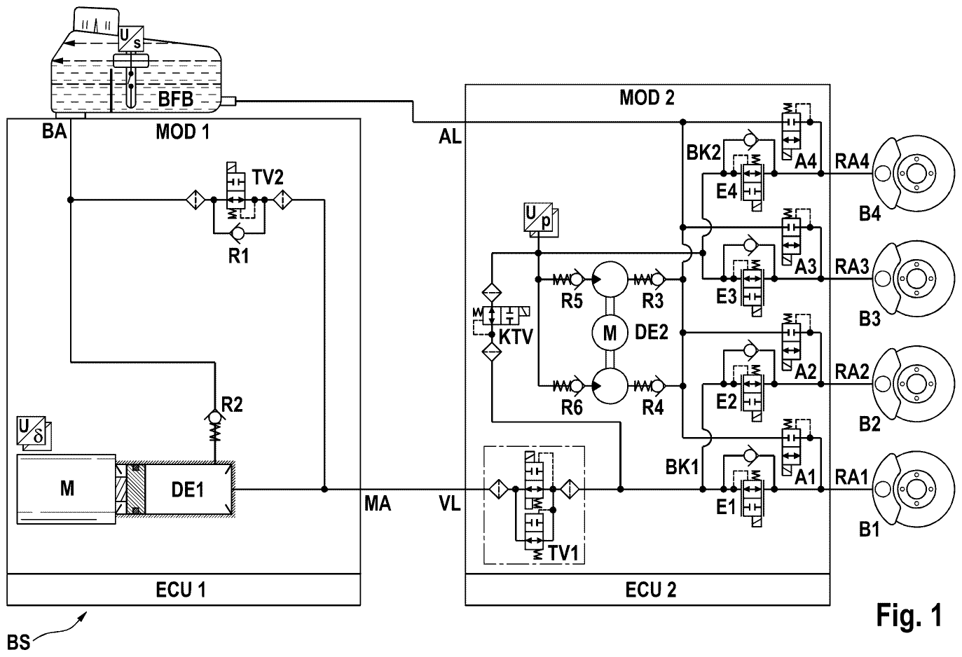

FIG. 1 shows a braking system BS according to a first exemplary embodiment of the invention. The braking system BS comprises a first module MOD1 and a second module MOD2. The first module MOD1 has a first electronic control device ECU1 and the second module MOD2 has a second electronic control device ECU2. The electronic control devices ECU1, ECU2 control the respective module MOD1, MOD2 and can also realize distributed functions. In particular, they have independent power supplies, and therefore, in principle, failure of one of the modules MOD1, MOD2 does not lead to the failure of the respective other module MOD2, MOD1.

A first electrical pressure supply device DE1 is arranged in the first module MOD1. Said pressure supply device is embodied here as a linear actuator. It is connected via a non-return valve R2 to a reservoir port BA, which in turn is connected to a brake fluid reservoir BFB. This enables replenishment of the first electrical pressure supply device DE1.

On the output side, the first electrical pressure supply device DE1 is connected to a module port MA. A connection between the first electrical pressure supply device DE1 and the module port MA is also connected to the reservoir port BA via a second separation valve TV2, to which a non-return valve R1 is connected in parallel.

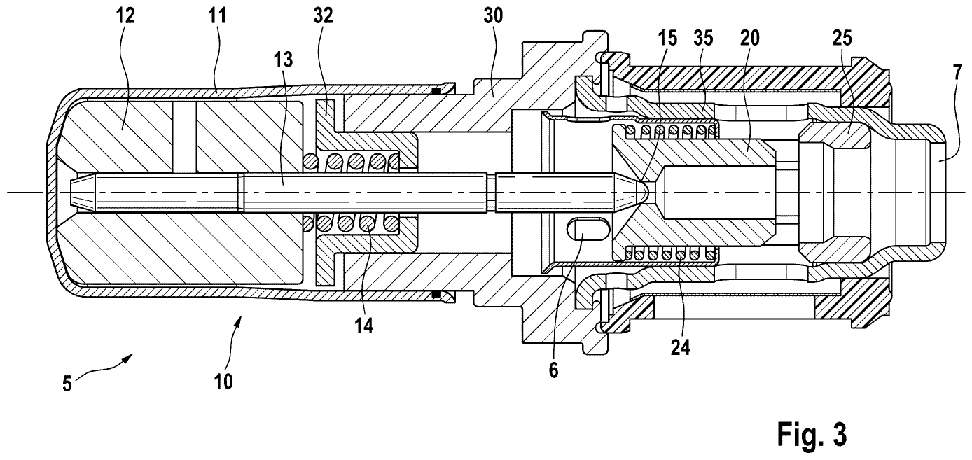

The module port MA is connected to the second module MOD2 via a connecting line VL. The connecting line VL opens into a first separation valve TV1, which is designed as described further below with reference to FIG. 3. In contrast to the module port MA, the first separation valve TV1 is connected to a first brake circuit BK1, which has two wheel ports RA1, RA2, which are each accessible via an inlet valve E1, E2 and are connected to wheel brakes B1, B2. Furthermore, the first separation valve TV1 and the first brake circuit BK1 are connected to a second brake circuit BK2 via a circuit separation valve KTV, as shown. The circuit separation valve KTV is normally open here. The second brake circuit BK2 has two further wheel ports RA3, RA4, which are accessible via respective inlet valves E3, E4 and are connected to wheel brakes B3, B4.

The wheel ports RA are connected to a connection line AL via respective outlet valves A1, A2, A3, A4. Said connection line leads directly to the brake fluid reservoir BFB, and therefore it does not need to pass through the first module MOD1. Said connection line AL is also connected to a suction side of a second electrical pressure supply device DE2. The latter is embodied here as a piston pump. The second electrical pressure supply device DE2 has two non-return valves R3, R4 on the input side and two other non-return valves R5, R6 on the output side. As shown, said non-return valves control the flow in just one direction through the second electrical pressure supply device DE2.

A pressure sensor U/P measures a pressure at the second brake circuit BK2.

The design of the first separation valve TV1 allows a parallel arrangement of a normally open 2/2-way separation valve and a second normally closed 2/2-valve (optionally a non-return valve) to be replaced by just one valve. It thus acts as a combined two-stage pressure switch-on and separation valve. If there is a positive pressure from the first brake circuit BK1, opening of the first separation valve TV1 is ensured even in the event of high positive pressure, if said separation valve is deactivated. After a certain reduction in pressure, the first separation valve TV1 opens completely so that a full throughflow is possible.

In a normal braking mode, pressurization can be carried out, for example, exclusively, by means of the first electrical pressure supply device DE1, or the second electrical pressure supply device DE2 can additionally also be used. For this purpose, typically, the first separation valve TV1 is open and the second separation valve TV2 is closed. The circuit separation valve KTV is typically open. In this case, the two pressure supply devices DE1, DE2 can act on the two brake circuits BK1, BK2 and provide a common pressure. Said pressure can be conducted in a suitable manner to the wheel ports RA via the inlet valves E1, E2, E3, E4. The pressure can be reduced again correspondingly wheel-specifically via the outlet valves A.

If pressure is intended to be built up exclusively by means of the second electrical pressure supply device DE2, the first separation valve TV1 can be closed. The first electrical pressure supply device DE1 is therefore no longer accessible. The circuit separation valve KTV is typically open so that the two brake circuits BK1 can be pressurized. By closing of the first separation valve TV1, pressure is in particular prevented from reaching the first pressure supply device DE1 and initially having to press a piston counter to the action of an uncharged motor before the pressure is fully available for building up at wheel ports RA.

If the second electrical pressure supply device DE2 fails, the first valve seat of the first separation valve TV1 can be opened counter to pressure. Brake pressure is thus reduced in the brake fluid reservoir BFB. This can be done in particular via an open second separation valve TV2. The second valve seat remains closed until the pressure is equalized, allowing the second valve seat to be opened counter to a spring.

In particular, the described design makes it possible to reduce the number of valves, coils and electrical drivers. Existing interfaces can be reused.

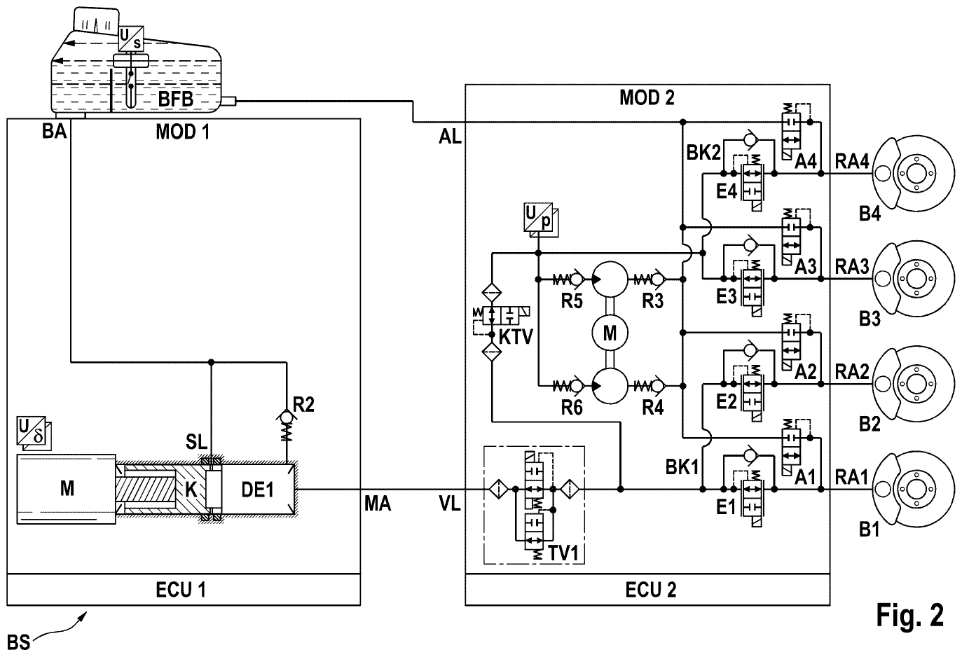

FIG. 2 shows a braking system BS according to a second exemplary embodiment of the invention. In contrast to the first exemplary embodiment, the second separation valve TV2 is omitted. Instead, the first electrical pressure supply device DE1 has a breather hole SL, which is directly connected to the reservoir port BA. The breather hole SL is only accessible from the inside of the first electrical pressure supply device DE1 when a piston K of the first electrical pressure supply device DE1 is in a fully retracted position, as shown. Intake is possible in this embodiment in the same way as in the first exemplary embodiment. However, a pressure reduction from the wheel ports RA to the brake fluid reservoir BFB is carried out differently, namely by the pressure being reduced through the first electrical pressure supply device DE1 and the breather hole SL to the reservoir port BA and thus to the brake fluid reservoir BFB. This allows a further saving on outlay since the second separation valve TV2 can be dispensed with.

FIG. 3 shows a possible embodiment of the first separation valve TV1.

The valve 5 is designed in principle as a 2/2-way valve. A normally open, electromagnetically actuated pilot valve 10 which has a sleeve 11, an armature 12, a plunger 13 and a first compression spring 14 is formed in said valve. The valve has a second valve seat 20, in which a first valve seat 15 of the pilot valve 10 is integrated and which forms the main stage with a valve plate 25.

A housing 30 receives the valve sleeve 11 on one side and provides a connection to a deep-drawn lower valve housing 35 on the other side.

In the housing 30, an adjustment sleeve 32 is pressed in in a displaceably adjustable manner, which allows an adjustment of the air gap between the magnetic poles of armature 12 and housing 30 to compensate for individual part tolerances.

An inlet 6 and an outlet 7 are formed in the valve 5. For example, the inlet 6 can be connected to the first brake circuit BK1. For example, the outlet 7 can be connected to the connecting line VL.

By application of a magnetic field, which can be generated in particular by a solenoid, not shown, the armature 12 and thus also the plunger 13 can be pushed to the right. This reliably closes the two valve seats 15, 20. The valve thus locks.

The first compression spring 14 is designed to be of such a strength that the armature 12 is pushed to the left in any case when the valve is not actuated, and therefore the first valve seat 15 is open. A second compression spring 24 pushes the second valve seat to the left into an open position, but is designed to be weaker. The complete opening of the valve 5 is thus possible only if a positive pressure at the inlet 6 relative to the outlet 7 is at most as large as a threshold value. The second valve seat 20 then opens, with the first valve seat 15 serving as an end stop of the associated movement and thus being closed.

In the application, this means that opening is in principle ensured when the valve 5 is switched off, but that the predominant part of the valve 5 has to be less strongly spring-loaded and thus a lower actuating energy is sufficient.

It is pointed out that features may be described in combination in the claims and in the description, for example in order to facilitate understanding, even though these can also be used separately from one another. A person skilled in the art will recognize that such features may also, independently of one another, be combined with other features or combinations of features.

Dependency references in dependent claims may characterize desirable combinations of the respective features but do not exclude other combinations of features.

### LIST OF REFERENCE SIGNS

BS Braking system
MOD Module
ECU Control devices
BA Reservoir port
BFB Brake fluid reservoir
R Non-return valve
DE Pressure supply device
SL Breather hole
MA Module port
VL Connecting line
AL Connection line
TV Separation valve
KTV Circuit separation valve
BK Brake circuit
E Inlet valve
A Outlet valve
RA Wheel port
B Brake
U/P Pressure sensor
5 Valve
6 Inlet
7 Outlet
10 Pilot valve
11 Sleeve
12 Armature
13 Plunger
14 First compression spring
15 First valve seat
20 Second valve seat
24 Second compression spring
25 Valve plate
30 Housing
32 Adjustment sleeve
35 Valve housing

1-15. (canceled)

16. A braking system for a motor vehicle, comprising:
a first module having at least one reservoir port and a module port;
a second module having a plurality of wheel ports;
a first electrical pressure supply device arranged in or on the first module and connected on the pressure side to the module port and connected on the suction side to the at least one reservoir port;
a second electrical pressure supply device arranged in or on the second module and connected on the pressure side to the plurality of wheel ports; and
a first separation valve connected in the second module between the module port and the wheel port;
wherein the second electrical pressure supply device is connected on the pressure side to a connection between a first separation valve and at least some of the wheel ports;
wherein the first separation valve has a first valve seat and a second valve seat, wherein the valve seats hydraulically connected in parallel with the second valve seat having a larger passage than the first valve seat;
wherein the first separation valve is normally open;
wherein the first valve seat and the second valve seat are jointly closable by actuation of the first separation valve; and
wherein the second valve seat is spring-loaded in such a way that, if the first separation valve is not actuated, the second valve seat only opens if a positive pressure on the side of the second electrical pressure supply device is less than a threshold value.

17. The braking system as claimed in claim 16, wherein no non-return valve is connected parallel to the first separation valve.

18. The braking system as claimed in claim 16, further comprising a second separation valve connected on the one hand to a connection between the first electrical pressure supply device and the first separation valve and connectable on the other hand to a brake fluid reservoir.

19. The braking system as claimed in claim 18, wherein, parallel to the second separation valve, a non-return valve with a passage direction from the brake fluid reservoir is connected to the connection between the first electrical pressure supply device and the first separation valve.

20. The braking system as claimed in claim 18, wherein the second separation valve is normally open.

21. The braking system as claimed in claim 16,
wherein the module port is connected exclusively to the first electrical pressure supply device,
wherein the first electrical pressure supply device includes a breather hole, which is opened only in an inoperative state of the first pressure supply device, and
wherein the breather hole is connected to the reservoir port.

22. The braking system as claimed in claim 16,
wherein at least one non-return valve with a passage direction to the second electrical pressure supply device is connected directly on the input side to the second electrical pressure supply device, and/or
wherein at least one non-return valve with a passage direction away from the second electrical pressure supply device is connected directly on the output side to the second electrical pressure supply device.

23. The braking system as claimed in claim 16, wherein the first module has a first control device and the second module has a second control device separate from the first control device.

24. The braking system as claimed in claim 16, wherein the second electrical pressure supply device is connected via a circuit separation valve to the connection between the first separation valve and at least some of the wheel ports.

25. The braking system as claimed in claim 24,
wherein a first brake circuit and a second brake circuit are formed in the second module, wherein each brake circuit is assigned one or more wheel ports, and
wherein the first brake circuit is directly connected to the first separation valve.

26. The braking system as claimed in claim 25, wherein the second brake circuit is connected to the first brake circuit via the circuit separation valve.

27. The braking system as claimed in claims 25, wherein the second electrical pressure supply device is directly connected on the pressure side to the second brake circuit.

28. The braking system as claimed in claim 16,
wherein an inlet valve is in each case connected between the electrical pressure supply devices and the wheel ports, and/or
wherein the wheel ports are connected via respective outlet valves to a suction side of the second electrical pressure supply device and/or to a brake fluid reservoir.

29. The braking system as claimed in claim 16, further comprising a connection line originating from the second module for the direct connection to a brake fluid reservoir and which is connected to a suction side of the second electrical pressure supply device and/or to outlet valves.

30. The braking system as claimed in claim 16,
wherein the first electrical pressure supply device is a linear actuator, and
wherein the second electrical pressure supply device is a piston pump.
